(19) United States
(12) Patent Application Publication
(10) Pub. No.: US 2021/0180488 A1
(43) Pub. Date: Jun. 17, 2021

(54) EXHAUST PURIFICATION SYSTEM FOR INTERNAL COMBUSTION ENGINE

(71) Applicant: TOYOTA JIDOSHA KABUSHIKI KAISHA, Toyota-shi (JP)

(72) Inventors: Noriyasu ADACHI, Numazu-shi (JP); Noriyasu KOBASHI, Hachioji-shi (JP); Yusuke SAITO, Gotemba-shi (JP)

(73) Assignee: TOYOTA JIDOSHA KABUSHIKI KAISHA, Toyota-shi (JP)

(21) Appl. No.: 17/085,147

(22) Filed: Oct. 30, 2020

(30) Foreign Application Priority Data
Dec. 11, 2019 (JP) 2019-224033

(51) Int. Cl. F01N 3/029; F01N 3/023; F01N 11/00

(52) U.S. Cl. CPC F01N 3/029; F01N 3/0238; F01N 2900/1602; F01N 2260/04; F01N 2610/085; F01N 11/002

(57) ABSTRACT

An exhaust purification system includes a filter, an oxygen supply device, and a controller. The filter is configured to trap particulate matters contained in exhaust gas of an engine. The oxygen supply device is configured to supply oxygen contained in intake air of the engine to the filter. The controller is configured to execute filter regeneration processing to oxidize and remove the particulate matters deposited on the filter. The filter regeneration processing includes regeneration processing during an engine stop that is executed during a shut-down of the engine. In the regeneration processing during the engine stop, a future temperature of the filter is calculated. Then, an operation amount of the oxygen supply device is variably set based on a result of comparing the future temperature with an upper limit temperature of the filter.

### CROSS-REFERENCE TO RELATED APPLICATION

The present application claims priority under 35 U.S.C. § 119 to Japanese Patent Application No. 2019-224033, filed Dec. 11, 2019. The contents of this application are incorporated herein by reference in their entirety.

### TECHNICAL FIELD

The present disclosure relates to a system for purifying exhausts from an internal combustion engine (hereinafter also referred to simply as an “engine”).

### BACKGROUND

JP2009-209788A discloses an exhaust purifying device including a filter which is configured to trap particulate matters contained in emissions from the engine (hereinafter also referred to as a “PM”). This conventional device estimates an amount of the PM burned in the filter during an engine stop. The burning amount of the PM is estimated based on temperatures of the filter immediately before the engine stop and those when an engine operation is restarted.

### SUMMARY

However, the conventional device lacks a perspective of actively removing the PM deposited on the filter during the engine stop. Therefore, the filter may become clogged when a situation where the PM could not be removed during the engine operation has been repeated for a long time. Accordingly, it is desirable to make an improvement from a viewpoint of not missing opportunities to remove the PM.

With respect to this improvement, intentional oxygenation to the filter during the engine stop allows for an active elimination of the PM. However, when the PM reacts with oxygen, heat is generated. This heat of the reaction is also generated when the oxygen is supplied to the filter during the engine operation. However, an amount of the heat carried away by gases passing through the filter during engine stop is usually less than that during the engine operation. Therefore, when oxygen is intentionally supplied to the filter during the engine stop, temperature of the filter is easily reach the one at which an exhaust purifying function of the filter is impaired in a short time. Therefore, it is also desirable to make an improvement from another viewpoint of suppressing an excessive rise in the temperature of the filter.

It is an object of the present disclosure to provide a novel technique to remove the PM on the filter actively during the engine stop. Another object of the present disclosure is to reduce the excessive rise in the temperature of the filter associated with the removal of the PM performed during the engine stop.

The present disclosure is an exhaust purification system for internal combustion engine and has the following features.

The exhaust purification system comprises a filter, an oxygen supply device, and a controller.

The filter is configured to trap particulate matters contained in exhaust gas of the internal combustion engine.

The oxygen supply device is configured to supply oxygen contained in intake air of the internal combustion engine to the filter.

The controller is configured to execute filter regeneration processing to oxidize and remove the particulate matters deposited on the filter.

The filter regeneration processing includes regeneration processing during an engine stop that is executed during a shut-down of the internal combustion engine.

In the regeneration processing during the engine stop, the controller is configured to:

calculate a future temperature of the filter based on an accumulated amount of the particulate matters deposited on the filter, a present temperature of the filter, and an estimated pass amount of oxygen passing through the filter; and

variably set an operation amount of the oxygen supply device based on a result of a comparison between the future temperature and an upper limit temperature of the filter.

In the regeneration processing during the engine stop, the controller may be configured to:

if the future temperature is higher than the upper limit temperature, set the operation amount such that oxygen is not supplied to the filter.

In the regeneration processing during the engine stop, the controller may be configured to:

if the future temperature is lower than the upper limit temperature, set the operation amount such that oxygen is supplied to the filter.

In the regeneration processing during the engine stop, the controller may be configured to:

set the operation amount to an upper limit operation amount of the oxygen supply device.

According to present disclosure, the regeneration processing during the engine stop is executed. According to the regeneration processing during the engine stop, the operation amount of the oxygen supply device is variably set based on the comparison result between the future temperature and the upper limit temperature. If the operation amount is variably set, oxygen may be or may not be supplied to the filter. When oxygen is supplied to the filter, the PM is oxidized and removed. Therefore, it is possible to remove the PM actively during the engine stop. On the other hand, if no oxygen is supplied to the filter, an oxidation reaction of the PM does not proceed. Therefore, it is also possible to suppress the excessive rise of the temperature of the filter associated with the removal of the PM during the engine stop.

### BRIEF DESCRIPTION OF DRAWINGS

FIG. 1 is a diagram showing a configuration example of an exhaust purification system for internal combustion engine according to an embodiment.

FIG. 2 is a flow chart for explaining a processing flow of filter regeneration processing.

FIG. 3 is a flow chart describing a processing flow of the regeneration processing executed during an engine operation.

FIG. 4 is a diagram showing an example of a threshold map.

FIG. 5 is a flow chart explaining a processing flow of the filter regeneration processing executed during an engine stop.

### EMBODIMENT

Hereinafter, an embodiment of the present disclosure will be described with reference to drawings.

### 1. System Configuration

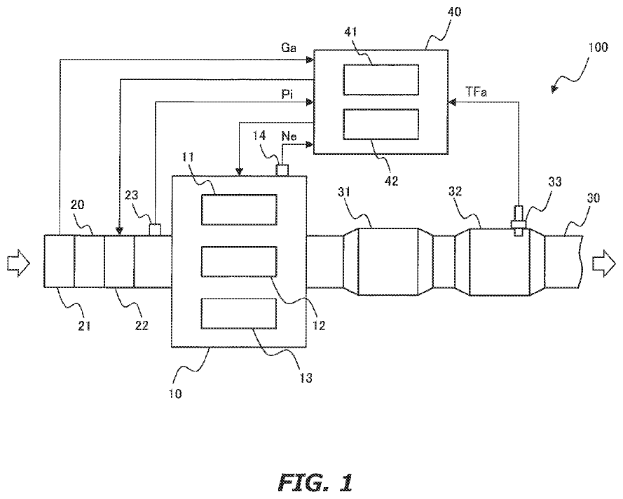

An exhaust purification system for internal combustion engine according to the embodiment of the present disclosure (hereinafter simply referred to as a “system”) is mounted on a conventional vehicle powered by the engine (hereinafter referred to as an “engine vehicle”) or on a hybrid vehicle powered by the engine and a motor. FIG. 1 is a diagram illustrating an configuration example of the system according to the embodiment of the present disclosure. A system 100 shown in FIG. 1 includes an engine 10 as a power source. An example of the engine 10 includes a gasoline engine. There is no particular limitation on number and arrangement of a cylinder of the engine 10.

The engine 10 includes an injection device 11, an ignition apparatus 12, a VVT (Variable Valve Timing) 13, and a crank angle sensor 14. The injection device 11 is configured to inject fuels into the cylinder of the engine 10. The ignition apparatus 12 is configured to ignite a mixed gas containing fuel and air. The VVT 13 is a variable valve timing mechanism in which an electric motor is used as an actuator, To the VVT 13, a known structure is applied. The VVT 13 is configured to change a valve timing of at least one of an intake air valve and an exhaust valve of the engine 10 by energizing the electric motor. As a result, a valve overlapping period OL in which the intake air valve and the exhaust valve are in an open state at the same time is changed. The crank angle sensor 14 is configured to detect rotation angle of a crank shaft.

The engine 10 also includes an intake pipe 20. An inlet portion of the intake pipe 20, an airflow sensor 21 is provided. The air flow sensor 21 is configured to measure a flow amount of an intake air (fresh air) flowing into the intake pipe 20 from an outside of the engine 10. In a middle of the intake pipe 20, an electronically controlled throttle valve 22 is provided. The throttle valve 22 is configured to regulate an amount of air (the intake air) flowing into the engine 10. This regulation is performed by changing an opening degree of the throttle valve 22 (hereinafter also referred to as a “throttle opening degree”). On a downstream of throttle valve 22, a pressure sensor 23 is provided. The pressure sensor 23 is configured to detect a pressure (hereinafter also referred to as an “intake pressure”) Pi of the gas flowing through the intake pipe 20.

The engine 10 also includes an exhaust pipe 30. An exhaust air from the engine 10 flows through the exhaust pipe 30. In a middle of the exhaust pipe 30, a three-way catalyst 31 is provided. The three-way catalyst 31 has a honeycomb-shaped and has a plurality of internal passages formed in a flow direction of the exhaust gas. Each of partition walls that divides these internal passages has a metal or a metal compound that purifies harmful components contained in the exhaust gas hydrogen carbon, carbon monoxide and nitrogen oxide, hereinafter referred to as an “exhaust element”).

On a downstream of the three-way catalyst 31, a filter 32 is provided. The filter 32 has a honeycomb-shaped and has a plurality of internal passages. Each of partition wall that divides these internal passages has a metal or a metal compound for purifying the exhaust element. The configuration up to this point is the same as that of the three-way catalyst 31. Unlike the three-way catalyst 31, the filter 32 has sealing members on an upstream end or a downstream end of the internal passage. The internal passage having the sealing member on the upstream end and that having the sealing member on the downstream end are arranged alternately and adjacently. According to such the configuration, the filter 32 traps the PM contained in the exhaust gas.

To the filter 32, a temperature sensor 33 which is configured to detect an actual temperature TFa of the filter 32 is attached.

The system 100 also includes an ECU (Electric Control Unit) 40 as a controller. The ECU 40 is a microcomputer that includes at least a processor 41 and a memory 42. The processor 41 executes various processing by executing computer programs. The various processing include filter regeneration processing. The detail of the filter regeneration processing will be described later. The memory 42 stores the computer programs, various databases and the like. The memory 42 also stores various kinds of data. The various kinds of data include rotation angle data from the crankshaft angle sensor 14, air flow amount data from the air flow sensor 21, and actual temperature data from the temperature sensor 33. The various kinds of data also include intake pressure data from the pressure sensor 23 and information on valve overlapping period OL (hereinafter also referred to as “overlapping information.”)

### 2. Filter Regeneration Processing

The filter regeneration processing is processing to oxidize and remove the PM trapped by the filter 32. When the filter regeneration processing is executed, a function of the filter 32 to trap the PM is regenerated. The filter regeneration processing includes regeneration processing during an engine operation and regeneration processing during an engine stop. The regeneration processing during the engine operation is carried out during the engine is operated. The regeneration processing during the engine stop is carried out during the engine 10 is shut down. A distinction between the operation and the shut-down is determined by whether rotational speed Ne of the engine 10 is higher than a threshold THNe. An example of the threshold THNe includes rotational speed when the rotation of the crankshaft is substantially in a shut-down state.

The regeneration processing during the engine operation is executed regardless of the type of the vehicle (i.e., the gasoline vehicle and the hybrid vehicle) on which the system 100 is mounted. If the system 100 is mounted on the hybrid vehicle, the rotational speed Ne decreases less than or equal to the threshold THNe during the hybrid vehicle is powered only by the motor, Therefore, when the system 100 is mounted on the hybrid vehicle, the regeneration processing during the engine stop is also executed while traveling only with the power from the motor. The regeneration processing during the engine stop may be executed when the vehicle on which the system 100 is mounted is being towed by another vehicle.

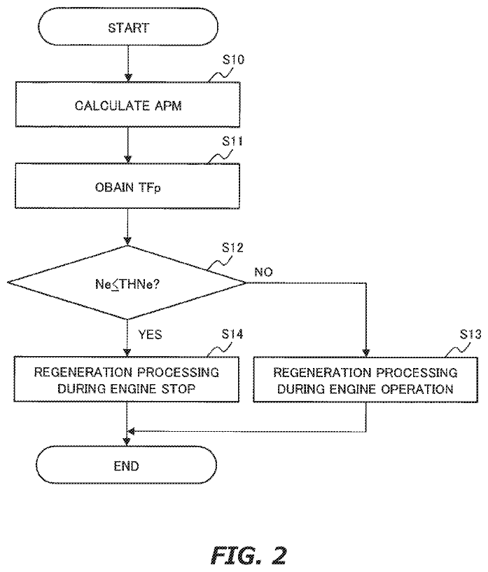

FIG. 2 is a flow chart for explaining a processing flow of the filter regeneration processing. The routine shown in FIG. 2 is repeatedly executed at a predetermined control cycle.

In the routine shown in FIG. 2, first, an accumulated amount APM is calculated (step S10). The accumulated amount APM is an amount of the PM deposited on the filter 32.

The accumulated amount APM is calculated, for example, based on an operation history of the engine 10. According to the operation history, a total amount EPM of the PM discharged from the engine 10 and a total amount RPM of the PM removed from the filter 32 in the filter regeneration processing are estimated. The accumulated amount APM is calculated, for example, from the following formula (1).

APM=EPM*RF−RPM (1)

In the formula (1), “RF2 denotes a trap rate of the PM in the filter 32.

In another example, the accumulated amount APM is calculated from a difference between pressure of the gas on the upstream of the filter 32 and that on the downstream of the filter 32. This pressure difference is calculated by detecting the pressure of the gas on the upstream of the filter 32 and that on the downstream thereof.

Subsequent to the step S10, present temperature TFp is obtained (step S11). The present temperature TFp is calculated based on actual temperature data.

Subsequent to the step S11, it is determined whether or not the rotational speed Ne is equal to or less than the threshold THNe (step S12). The rotational speed Ne is calculated based on the rotation angle data.

If the determination result of the step S12 is negative, the regeneration processing during the engine operation is executed (step S13). If the determination result of the judgement result of the step S12 is positive, the regeneration processing during the engine stop is executed (step S14). Hereinafter, the regeneration processing during the engine operation and the regeneration processing during the engine stop will be described.

### 2-1. Regeneration Processing During Engine Operation

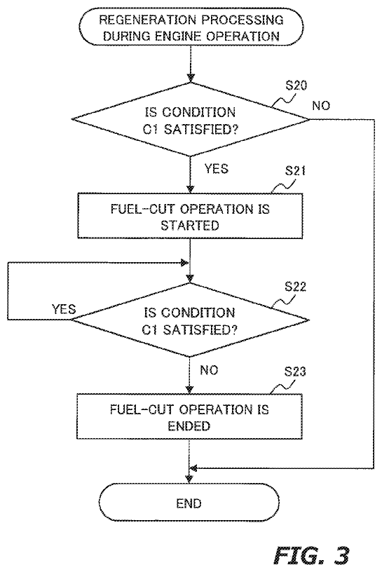

FIG. 3 is a flow chart for explaining processing flow of the regeneration processing during the engine operation. In the routine shown in FIG. 3, first, it is determined whether or not a condition C1 is satisfied (step S20). The condition C1 is a condition to determine whether or not to allow an oxidation of the PM deposited on the filter 32. The condition C1 includes the following conditions C11 to C13.

C11: The vehicle on which the system 100 is mounted is in a decelerating travel.

C12: The present temperature TFp of the filter 32 is higher than a lower limit temperature TFL.

C13: A future temperature TFf of the filter 32 is lower than an upper limit temperature TFH.

Regarding the condition C11, whether or not the vehicle on which the system 100 is mounted is in the decelerating travel is determined based on data detected by a vehicle speed sensor (or a wheel speed sensor).

Regarding the condition C12, an example of the lower limit temperature TFL includes temperature (e.g., 500 degree C.) at which a progress of the oxidation reaction of the PM on the filter 32 is ensured. For the present temperature TFp, the temperature calculated in the step S11 is used.

For the condition C13, the upper limit temperature TFH is set to a higher temperature than the lower limit temperature TFL. An example of the upper limit temperature TFH includes temperature at which a purification function of the filter 32 toward the exhaust element is ensured (e.g., 800 degree C.).

Further, regarding the condition C13, the future temperature TFf is the temperature of the filter 32 that is expected to rise during the filter regeneration processing. The future temperature TFf is calculated based on the accumulated amount APM, the present temperature TFp, and an estimated pass amount AO2. For the accumulated amount APM, the one calculated in the step S10 of FIG. 2 is used. For the present temperature TFp, the one calculated in the step S11 is used.

The estimated pass amount AO2 is an amount of oxygen that is estimated to pass through the filter 32 during the filter regeneration processing. The estimated pass amount AO2 is calculated based on the air flow amount data. The estimated pass amount AO2 may be calculated based on the intake pressure data and the overlapping information. The estimated pass amount AO2 may be calculated based on a difference between the intake pressure Pi and an exhaust pressure Pe, and the overlapping information. Note that the exhaust pressure Pc is obtained by detecting the pressure of the gas on the upstream of the three-way catalyst 31.

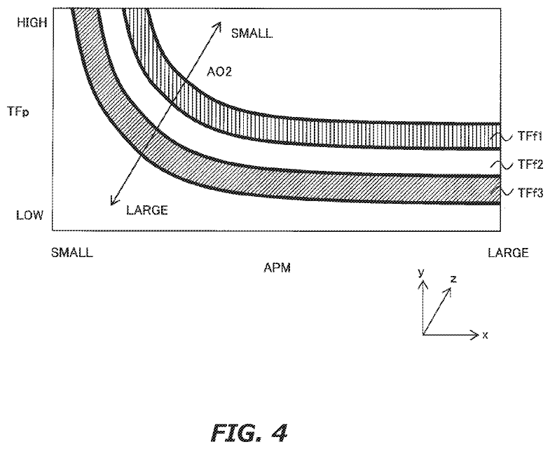

FIG. 4 is a diagram for explaining the future temperature TFf. The x-axis of FIG. 4 represents the accumulated amount APM, the y-axis represents the present temperature TFp of the filter 32, and the z-axis represents the estimated pass amount AO2. The oxidation reaction of the PM is an exothermic reaction. Therefore, as the present temperature TFp increases, the oxidative reaction of the PM tends to proceed, and the future temperature TFf tends to increase. Also, the more the PM or oxygen (i.e., the accumulated amount APM or the estimated pass amount AO2) that is a reactant, the more likely the future temperature TFf tends to increase. Therefore, it can be seen that when the accumulated amount APM and the present temperature TFp are fixed, the more the estimated pass amount AO2, the higher the future temperature TFf becomes. Thus, a future temperature TFf3 is higher than a future temperature TFf2 and the future temperature TFf2 is higher than a future temperature TFf1.

In the present embodiment, a three-dimensional data map defining a relationship among the accumulated amount APM, the present temperature TFp, the estimated pass amount AO2, and the future temperature TFf is stored in the memory 42, In the step S20, the future temperature TFf is calculated by referring to the three-dimensional data map using the accumulated amount APM, the present temperature TFp and the estimated pass amount AO2 as inputs thereto. The figure temperature TFf may be calculated by referring to a two-dimensional data map defining a relationship among the accumulated amount APM, the present temperature TFp, and the future temperature TFf.

If the determination result of the step S20 is positive, fuel-cut operation is started (step S21). In the fuel-cut operation, fuel injection from the injection device 11 is prohibited. In the fuel-cut operation, an energization of the ignition apparatus 12 is also prohibited. When the fuel-cut operation is executed, oxygen that has passed through the engine 10 flows into the filter 32, thereby the oxidative reaction of the PM proceeds. Note that a stoichiometric operation is executed prior to the execution of the fuel-cut operation. In the stoichiometric operation, all the oxygen is consumed in the cylinder of the engine 10. Therefore, when the stoichiometric operation is executed, oxygen does not flow into the filter 32 and the oxidation reaction of the PM does not proceed.

Subsequent to the step S21, it is determined whether or not the condition C1 is satisfied (step S22). The content of the processing of the step S22 is the same as that in the step S20. For example, when a driver of the vehicle depresses an accelerator pedal, the condition C11 is not satisfied. When the future temperature TFf is equal to or larger than the upper limit temperature TFH, the condition C13 is not satisfied. The reason why the condition C13 is not satisfied is as follows. That is, during the processing of the routine shown in FIG. 3, the calculation of the accumulated amount APM and the estimated pass amount AO2 is repeatedly performed. In addition, the calculation of the future temperature TFf based on these calculated values and the present temperature TFp is also repeatedly performed. Therefore, the condition C13 cannot be satisfied when the future temperature TFf becomes equal to or larger than the upper limit temperature TFH.

The processing of the step S22 is repeatedly executed until a negative determination result is obtained. If the determination result of the step S22 is negative, the execution of the fuel-cut operation is ended (step S23). After the fuel-cut operation is ended, the stoichiometric operation is executed.

Incidentally, in the routine shown in FIG. 3, the fuel-cut operation is executed when the condition C1 is satisfied. However, a lean-burn operation may be executed when the condition C1 is satisfied. When the lean-burn operation is performed, oxygen that has not been consumed in the cylinder of the engine 10 flows into the filter 32, thereby the oxidation reaction of the PM proceeds. Note that the estimated pass amount 402 when the lean-burn operation is executed differs from that when the fuel-cut operation is executed. Therefore, when the lean-burn operation is executed, the future temperature. TFf is calculated by referring to a data map that is different from the data map described above.

### 2-2. Regeneration Processing During Engine Stop

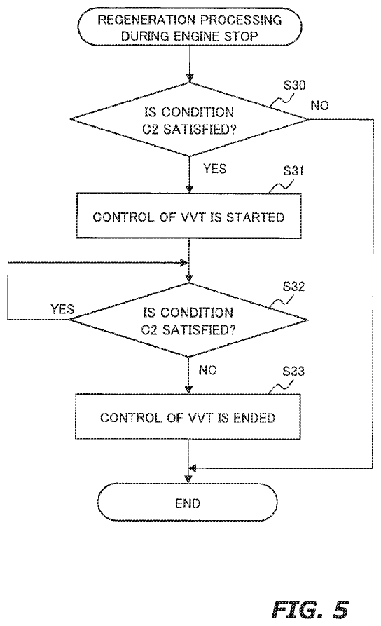

FIG. 5 is a flow chart for explaining processing flow of the regeneration processing during the engine stop. In the routine shown in FIG. 5, first, it is determined whether or not the condition C2 is satisfied (step S30), The condition C2 is a condition to determine whether or not to allow the oxidation of the PM deposited on the filter 32. The condition C2 includes the following conditions C21 and C22.

C21: The present temperature TFp is higher than the lower limit temperature TFL

C22: The future temperature TFf is lower than the upper limit temperature TFH

The condition C21 is the same as the condition C12. The condition C22 is basically the same as the condition C13. However, in the regeneration processing during the engine stop, control of the VVT 13 is executed when the condition C2 is satisfied. Therefore, the estimated pass amount AO2 used for the calculation of the future temperature TFf of the condition C22 is calculated based on the intake pressure data and the overlapping information. The estimated pass amount AO2 may be calculated based on the difference between the intake pressure Pi and the exhaust pressure Pe, and the overlapping information.

If the determination result of the step S30 is positive, the control of the VVT 13 is started (step S31). Specifically, an operation amount of the VVT 13 is set such that the valve overlapping period OL is longer than a reference value. An example of the reference value includes the valve overlapping period OL in which relative phase to the crankshaft with respect to the intake and exhaust cam shafts are zero. When the valve overlapping period OL becomes longer than the reference value, oxygen that has passed through engine 10 flows into the filter 32 thereby the oxidation reaction proceeds.

The operation amount of the VVT 13 may be set to a period corresponding to an upper limit operation amount of the VVT 13. An example of the upper limit operation amount includes an operation amount corresponding to a maximum advance value of the intake cam phase and a operation amount corresponding to a largest retard value of the exhaust earn phase. If the operation amount of the VVT 13 is set to the upper limit operation amount, it is possible to remove the PM in a short time.

If a throttle opening degree is zero (i.e., the gas flow from upstream to downstream of the throttle valve 22 is blocked by the throttle valve 22), an operation amount of the throttle valve 22 is set such that the throttle opening degree is greater than zero. Note that the throttle opening degree is calculated based on detected data from a throttle sensor.

Subsequent to the step S31, it is determined whether or not the condition C2 is satisfied (step S32). The content of the processing of the step S32 is the same as that of the step S30. For example, when the hybrid vehicle travels only by the operation of the motor and the present temperature TFp drops below the lower limit temperature TFL, the condition C21 is not satisfied. When the future temperature TTf is equal to or greater than the upper limit temperature TFH, the condition C22 is not satisfied. The reason why the condition C22 is not satisfied is the same as that of the condition C13.

The processing of the step S32 is repeatedly executed until the negative determination result is obtained. If the determination result of the step S32 is negative, the control of the VVT 13 is ended (step S33). If the control of the throttle valve 22 is executed in parallel with that of the VVT 13, both are ended.

### 3. Effect

According to the embodiment described above, the filter regeneration processing is executed not only during the operation of the engine 10 but also during the shut-down of the engine 10, Therefore, it is possible to remove the PM actively. In particular, according to regeneration processing during the engine stop, even if the regeneration processing during the engine operation cannot be executed for a long period, it is possible to remove the PM during the shut-down of the engine 10 and suppress a clogging of the filter 32.

Further, according to the filter regeneration processing, when it is determined during the processing that the future temperature TFf is equal to or greater than the upper limit temperature TFH, the execution of the processing is immediately ended. Therefore, it is possible to suppress an excessive rise in the temperature of the filter 32 caused by the execution of the filter regeneration processing. Therefore, it is possible to prevent the purification function of the filter 32 toward the exhaust element from being impaired,

### 4. Correspondence Between Embodiment and Present Disclosure

In the embodiment described above, the VVT 13 or a combination of the VVT 13 and the throttle valve 22 corresponds to the “oxygen supply device” of the present disclosure,

What is claimed is:

1. An exhaust purification system for internal combustion engine comprising:
a filter which is configured to trap particulate matters contained in exhaust gas of the internal combustion engine;
an oxygen supply device which is configured to supply oxygen contained in intake air of the internal combustion engine to the filter; and
a controller which is configured to execute filter regeneration processing to oxidize and remove the particulate matters deposited on the filter,
wherein the filter regeneration processing includes regeneration processing during an engine stop that is executed during a shut-down of the internal combustion engine,
wherein, in the regeneration processing during the engine stop, the controller is configured to:
calculate a future temperature of the filter based on an accumulated amount of the particulate matters deposited on the filter, a present temperature of the filter, and an estimated pass amount of oxygen passing through the filter; and
variably set an operation amount of the oxygen supply device based on a result of a comparison between the future temperature and an upper limit temperature of the filter.

2. The exhaust purification system according to claim 1,
wherein, in the regeneration processing during the engine stop, the controller is further configured to:
if the future temperature is higher than the upper limit temperature, set the operation amount such that oxygen is not supplied to the filter.

3. The exhaust purification system according to claim 1,
wherein, in the regeneration processing during the engine stop, the controller is further configured to:
if the future temperature is lower than the upper limit temperature, set the operation amount such that oxygen is supplied to the filter.

4. The exhaust purification system according to claim 3,
wherein, in the regeneration processing during the engine stop, the controller is further configured to:
set the operation amount to an upper limit operation amount of the oxygen supply device.
